(19) United States
(12) Patent Application Publication
(10) Pub. No.: US 2013/0327851 A1
(43) Pub. Date: Dec. 12, 2013

(54) FUEL INJECTION VALVE

(71) Applicants: Tatsuo Kobayashi, Toyota-shi (JP); Keisuke Komori, Toyota-shi (JP)

(72) Inventors: Tatsuo Kobayashi, Toyota-shi (JP); Keisuke Komori, Toyota-shi (JP)

(73) Assignee: TOYOTA JIDOSHA KABUSHIKI KAISHA, Toyota-shi, Aichi-ken (JP)

(21) Appl. No.: 14/000,937

(22) PCT Filed: Feb. 23, 2011
(86) PCT No.: PCT/JP2011/054017

§ 371 Date: Aug. 22, 2013

(51) Int. Cl. F02M 61/16

(52) U.S. Cl. CPC F02M 61/163
USPC 239/489

(57) ABSTRACT

A fuel injection valve includes: a nozzle body having a nozzle hole formed in a front edge portion thereof; a spiral flow path that gives a swirling component to a fuel which passes through the nozzle body toward the nozzle hole; and a pre-injection swirl flow generating unit that causes the fuel to flow through the spiral flow path before the nozzle hole is opened, wherein the pre-injection swirl flow generating means is communicated with the spiral flow path at a downstream side of the spiral flow path, and includes a suction chamber whose volume is expanded before the nozzle hole is opened.

### TECHNICAL FIELD

The present invention is related to a fuel injection valve.

### BACKGROUND ART

Recently, supercharged lean burn, extensive EGR, and homogeneous charge ignition combustion are briskly researched for CO₂ reduction and emission reduction with respect to an internal combustion engine. According to these researches, in order to pull out the effect of the CO₂ reduction and the emission reduction to the utmost, it is necessary to acquire a stable combustion state in vicinity to a combustion limit. While depletion of an oil fuel progresses, the robustness in which even various fuels, such as a biofuel, can be stably burned is required. The most important point for obtaining such stable combustion is to reduce the ignition fluctuation of a fuel-air mixture, and to require prompt combustion in which a fuel is burned out in an expansion stroke.

Then, in the fuel supply of the internal combustion engine, a cylinder injection system which directly injects the fuel into a combustion chamber is employed for the improvement in transient response, the improvement in volumetric efficiency by latent heat of vaporization, and large retard combustion for catalytic activation in a low temperature. However, by employing the cylinder injection system, combustion fluctuation has been promoted by oil dilution caused by a spray fuel colliding with a combustion chamber wall as a droplet, and the aggravation of spray caused by deposit generated around a nozzle hole of an injection valve with the use of a liquid fuel.

In order to take measures against the oil dilution and the aggravation of the spray caused by employing such a cylinder injection system, to reduce the ignition fluctuation, and to realize stable combustion, it is important to atomize the spray so that the fuel in the combustion chamber evaporates promptly.

In order to atomize the spray injected from the fuel injection valve, there are known a method for using a shearing force of a thinned liquid film, a method for using cavitation caused by exfoliation of flow, a method for atomizing the fuel adhering to a surface by using mechanical vibration of an ultrasonic wave, and so on.

Patent Document 1 discloses a fuel injection valve that injects the fuel mixed with bubbles caused by using a differential pressure between a bubble generation path and a bubble keeping path, and atomizes the fuel by energy in which the bubbles collapse in the fuel after the injection.

Thus, various proposals are made to the fuel injection valve.

### PRIOR ART DOCUMENT

### Patent Document

[Patent Document 1] Japanese Patent Application Publication No. 2006-177174

### SUMMARY OF THE INVENTION

### Problems to be Solved by the Invention

However, the fuel injection valve disclosed in the Patent Document 1 is configured so that a seat portion is arranged at a downstream side of the bubble keeping path. Therefore, the fuel once kept in the bubble keeping path is injected in an initial stage of the injection. A bubble mixing rate of the fuel kept in the bubble keeping path in a valve closed state is low, the atomization in the initial stage of injection is difficult, and hence it is concerned about the fuel colliding with a cylinder wall as a liquid state. Making the liquid fuel collide with the cylinder wall causes oil dilution.

An object of the fuel injection valve disclosed herein is to inject a fuel containing a bubble from the initial stage of fuel injection from a nozzle hole, and atomize the fuel by collapsing the bubble after the injection.

### Means for Solving the Problems

To solve the above problem, a fuel injection valve disclosed herein includes: a nozzle body having a nozzle hole formed in a front edge portion thereof; a spiral flow path that gives a swirling component to a fuel which passes through the nozzle body toward the nozzle hole; and a pre-injection swirl flow generating means that causes the fuel to flow through the spiral flow path before the nozzle hole is opened.

Since swirling flow is generated before the beginning of the injection, an air column is generated by the swirling flow immediately after the nozzle hole is opened, fine bubbles are generated, and hence the fuel can be atomized. Here, the bubbles in the fuel is mainly generated by the air column generated by the swirling flow, i.e., generated in a boundary between the fuel and a columnar air formed in the swirling flow.

The pre-injection swirl flow generating means can be provided at a downstream side of the spiral flow path, and include a fuel suction means that sucks the fuel in the spiral flow path to the downstream side of the spiral flow path before the nozzle hole is opened.

The fuel is sucked by the fuel suction means, so that the fuel can be introduced from the spiral flow path to a nozzle hole side before the nozzle hole is opened. The swirling component is given to the fuel which passes through the spiral flow path. Thereby, the air column is generated immediately after the nozzle hole is opened, and hence the fuel can be atomized.

The pre-injection swirl flow generating means can be communicated with the spiral flow path at the downstream side of the spiral flow path, and include a suction chamber whose volume is expanded before the nozzle hole is opened. The volume of the suction chamber is expanded, so that a negative pressure is generated. Thereby, the swirling component is given to the fuel accumulated in the spiral flow path in the valve closed state, and the fuel can be sucked to the nozzle hole side. As a result, the air column is generated immediately after the beginning of the injection, and hence the fuel can be atomized.

The pre-injection swirl flow generating means can include: a needle member that is slidably arranged in the nozzle body, and rises toward a rear edge side of the nozzle body at the time of fuel injection to expand a first gap between an inner circumferential surface of the nozzle body and the needle member; and a valve member that begins movement to the rear edge side of the nozzle body after the beginning of the rise of the needle member to open the nozzle hole.

When the needle member rises in a state where the valve member has closed the nozzle hole, the volume of the first gap is increased and the negative pressure is generated. Thereby, the fuel can be sucked from the spiral flow path. The swirling component is given to the sucked fuel. The first gap can function as a suction chamber. The valve member begins to rise after the beginning of the rise of the needle member. Thereby, the nozzle hole can be opened after the volume of the first gap is increased.

The valve member can be sphere. A valve member is formed in a spherical form, so that alignment of the valve member becomes easy, and sealing performance of the fuel is improved.

The pre-injection swirl flow generating means can include: a needle member that is slidably arranged in the nozzle body, forms a first gap between an inner circumferential wall of the nozzle body and the needle member before fuel injection, and rises to a rear edge side of the nozzle body at the time of the fuel injection; a valve member that is mounted inside a recess formed in a front edge portion of the needle member, forms a second gap between the needle member and the valve member, begins movement to the rear edge side of the nozzle body after the beginning of the rise of the needle member to open the nozzle hole, and includes a first communication hole which communicates the first gap with the second gap; and an elastic member that is arranged in the second gap, and biases the valve member in a direction closing the nozzle hole.

When the needle member rises, the volume of the second gap is increased and the negative pressure is generated in the second gap. When the negative pressure is generated in the second gap, the fuel in the spiral flow path is drawn into a side of the second gap via the first gap, and the flow of the fuel to which the swirling component has been given can be generated before the injection of the fuel.

It is desirable that the first communication hole extends in a directions along a flow direction of the fuel which passes through the spiral flow path. Since the fuel which begins to be sucked to the second gap side flows smoothly, the swirling component is efficiently given to the flow of the fuel.

The needle member can include: a hook step that hooks with a hook flange included in the valve member in the recess formed in the front edge portion of the needle member, and forms a third gap between the hook flange and the hook step; and a second communication hole that communicates the third gap with the outside of the needle member.

The valve member begins to rise after timing of beginning of the rise of needle member. That is, after the rise of the needle member is begun, the closing of the nozzle hole is continued for a while. In order to create a gap of the timings of the rise of such both members, the valve member can include the hook flange and the needle member can include the hook step. When the hook flange engages with the hook step included in the rising needle member, the valve member begins to rise, but for the meantime, the third gap exists between the hook flange and the hook step. When the fuel exists in the third gap, it is considered that it becomes difficult that the hook flange approaches the hook step. Therefore, the needle member can include second communication holes that can discharge the fuel in the third gap outside the needle member.

It is desirable that the second communication hole extends in a directions along a flow direction of the fuel which passes through the spiral flow path. This is because the flow of the fuel discharged from the third gap does not interrupt the flow of the fuel that has passed through the spiral flow path.

The valve member can form a third communication hole that communicates the second gap with the third gap. The third communication hole is used for discharging the fuel in the third gap to the second gap side and facilitating the hookup of the hook flange and the hook step when the hook flange approaches the hook step. The third communication hole is provided instead of or along with the second communication hole.

The pre-injection swirl flow generating means can include: a fuel exhaust hole that is provided in the nozzle body, is opened and closed by the needle member, and discharges the fuel outside the nozzle body before the nozzle hole is opened. The fuel that includes the fine bubble and generates an air-fuel mixture is discharged outside the nozzle body before the nozzle hole which injects the fuel is opened, so that the fuel in the spiral flow path is introduced to the nozzle hole side. Thereby, the swirling component is given to the fuel.

It is desirable that the fuel exhaust hole extends in a directions along a flow direction of the fuel which passes through the spiral flow path. It is because the flow of the fuel which flows through the spiral flow path is not interrupted.

### Effects of the Invention

According to the fuel injection valve disclosed herein, it is possible to inject a fuel containing a bubble from an initial stage of fuel injection from a nozzle hole, and atomize the fuel by collapsing the bubble after the injection.

### BRIEF DESCRIPTION OF THE DRAWINGS

FIG. 1 is a diagram illustrating an example of the structure of an engine system equipped with a fuel injection valve;

FIG. 2 is an explanatory diagram illustrating the schematic structure of the fuel injection valve according to a first embodiment;

FIG. 3 is an enlarged explanatory diagram of a front edge portion of the fuel injection valve in a valve closed state according to the first embodiment;

FIG. 4 is an enlarged explanatory diagram of the front edge portion of the fuel injection valve according to the first embodiment in which a needle member rises and a first gap (i.e., a suction chamber) is expanded while a valve closed state of the nozzle hole is maintaining;

FIG. 5 is an enlarged explanatory diagram of the front edge portion of the fuel injection valve in a valve opened state according to the first embodiment;

FIG. 6 is a graph illustrating a distribution rate of the particle diameter of the fuel injected by the fuel injection valve according to the first embodiment by comparing the fuel injection valve according to the first embodiment with a fuel injection valve of a comparative example;

FIG. 7A is an explanatory diagram illustrating a shape of the nozzle hole of the fuel injection valve of the comparative example, as viewed from a lower surface side of the nozzle hole;

FIG. 7B is an explanatory diagram illustrating a shape of the nozzle hole of the fuel injection valve of the comparative example, as viewed from the side of the nozzle hole;

FIG. 8A is a photograph in which the state of fine bubbles in the fuel injected by the fuel injection valve of the comparison example is captured;

FIG. 8B is a photograph in which the state of fine bubbles in the fuel injected by the fuel injection valve of the first embodiment is captured;

FIG. 9 is an enlarged explanatory diagram of the front edge portion of the fuel injection valve in the valve closed state according to a second embodiment;

FIG. 10 is an enlarged explanatory diagram of the front edge portion of the fuel injection valve according to the second embodiment in which the needle member rises and the first gap (i.e., the suction chamber) is expanded while the valve closed state of the nozzle hole is maintaining;

FIG. 11 is an enlarged explanatory diagram of the front edge portion of the fuel injection valve in the valve opened state according to the second embodiment;

FIG. 12 is an enlarged explanatory diagram of the front edge portion of the fuel injection valve according to a third embodiment in which the needle member rises and the first gap (i.e., the suction chamber) is expanded while the valve closed state of the nozzle hole is maintaining;

FIG. 13 is an enlarged explanatory diagram of the front edge portion of the fuel injection valve in the valve closed state according to a fourth embodiment;

FIG. 14 is an enlarged explanatory diagram of the front edge portion of the fuel injection valve according to the fourth embodiment in which the needle member rises and the volume of a second gap (i.e., an suction chamber) is expanded while the valve closed state of the nozzle hole is maintaining;

FIG. 15 is an enlarged explanatory diagram of the front edge portion of the fuel injection valve in the valve opened state according to the fourth embodiment;

FIG. 16A-1 is a cross-section diagram of a valve member according to the fourth embodiment;

FIG. 16A-2 is a diagram of the valve member according to the fourth embodiment, as viewed from below;

FIG. 16B is a diagram of the valve member according to the fifth embodiment, as viewed from below;

FIG. 17 is an enlarged explanatory diagram of the front edge portion of the fuel injection valve in the valve closed state according to a sixth embodiment;

FIG. 18 is an enlarged explanatory diagram of the front edge portion of the fuel injection valve according to the sixth embodiment in which the needle member rises while the valve closed state of the nozzle hole is maintaining;

FIG. 19A-1 is a cross-section diagram of the needle member according to the sixth embodiment;

FIG. 19A-2 is a diagram of the needle member according to the sixth embodiment, as viewed from below;

FIG. 19B is a diagram of the needle member according to a seventh embodiment, as viewed from below;

FIG. 20A is an enlarged explanatory diagram of the front edge portion of the fuel injection valve in the valve closed state according to an eighth embodiment;

FIG. 20B is a cross-section diagram of the valve member according to the eighth embodiment;

FIG. 20C is a diagram of the valve member according to the eighth embodiment, as viewed from below;

FIG. 21 is an enlarged explanatory diagram of the front edge portion of the fuel injection valve according to the eighth embodiment in which the needle member rises while the valve closed state of the nozzle hole is maintaining;

FIG. 22 is an enlarged explanatory diagram of the front edge portion of the fuel injection valve in the valve closed state according to a ninth embodiment;

FIG. 23 is an enlarged explanatory diagram of the front edge portion of the fuel injection valve according to the ninth embodiment in which the needle member rises and the fuel is discharged from a fuel discharge hole while the valve closed state of the nozzle hole is maintaining;

FIG. 24 is an enlarged explanatory diagram of the front edge portion of the fuel injection valve in the valve opened state according to the ninth embodiment;

FIG. 25A-1 is a cross-section diagram of a nozzle body according to the ninth embodiment;

FIG. 25A-2 is a diagram of the nozzle body according to the ninth embodiment, as viewed from below; and

FIG. 25B is a diagram of the nozzle body according to a tenth embodiment, as viewed from below.

### MODES FOR CARRYING OUT THE INVENTION

Hereinafter, a description will be given of an embodiment of the present invention with reference to the drawings. It should be noted that a size and ratio of each portion do not correspond to the actual ones in some drawings. Also, a detail illustration is omitted in some drawings.

### First Embodiment

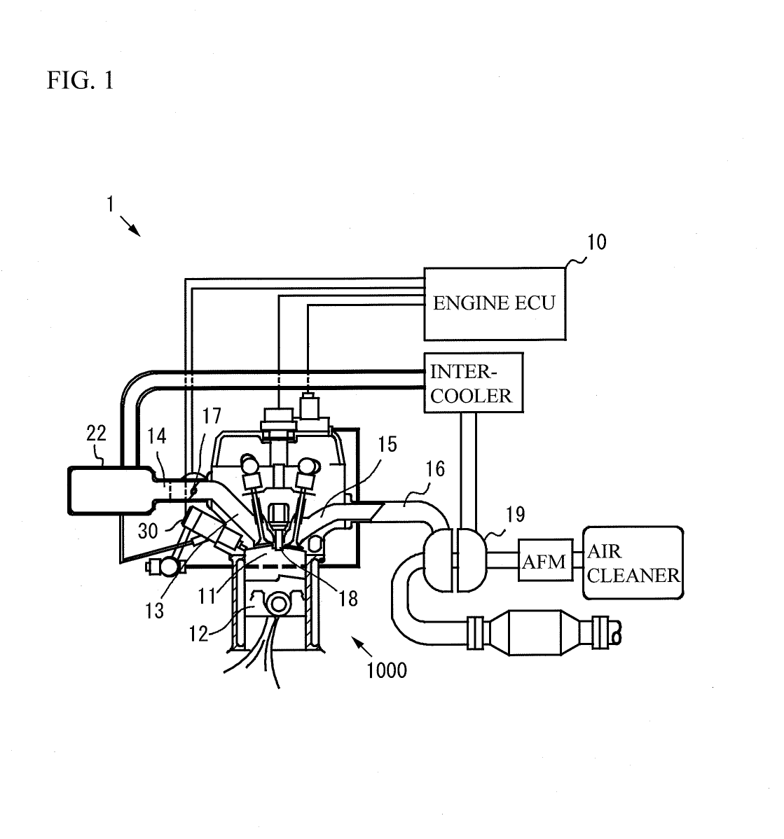

A first embodiment of the present invention is described with reference to the drawings. FIG. 1 is a diagram illustrating an example of the structure of an engine system 1 equipped with a fuel injection valve 30. Here, FIG. 1 illustrates only a part of the structure of an engine 1000.

The engine system 1 illustrated in FIG. 1 is equipped with the engine 1000 as a power source, and an engine ECU (Electronic Control Unit) 10 that comprehensively controls driving operation of the engine 1000. The engine system 1 is equipped with a fuel injection valve 30 that injects a fuel into a combustion chamber 11 of the engine 1000. The engine ECU 10 has a function of a controller. The engine ECU 10 is a computer that includes a CPU (Central Processing Unit) performing an arithmetic process, a ROM (Read Only Memory) storing a program, and a RAM (Random Access Memory) and a NVRAM (Non Volatile RAM) storing data.

The engine 1000 is an engine to be equipped with a vehicle, and includes a piston 12 which constitutes the combustion chamber 11. The piston 12 is slidably fitted into a cylinder of the engine 1000. Then, the piston 12 is coupled with a crankshaft which is an output shaft member, via a connecting rod.

A suction air flowed into the combustion chamber 11 from a suction port 13 is compressed in the combustion chamber 11 by the upward movement of the piston 12. The engine ECU 10 decides fuel injection timing and transmits a signal to the fuel injection valve 30, based on information on a position of the piston 12 from a crank angle sensor and a rotary phase of a camshaft from a suction cam angle sensor. The fuel injection valve 30 injects the fuel at specified injection timing in response to the signal from the engine ECU 10. The fuel injected from the fuel injection valve 30 is atomized to be mixed with the compressed suction air. The fuel mixed with the suction air is ignited with a spark plug 18 to be burned, so that combustion chamber 11 is expanded to move the piston 12 downwardly. The downward movement is changed to the rotation of the crankshaft via the connecting rod, so that the engine 1000 obtains power.

The combustion chamber 11 is connected to the suction port 13. A suction path 14 which introduces the suction air to the combustion chamber 11 via the suction port 13 is connected to the suction port 13. Further, the combustion chamber 11 of each cylinder is connected to an exhaust port 15. An exhaust path 16 which introduces an exhaust gas generated in the combustion chamber 11 to the outside of the engine 1000 is connected to the exhaust port 15. A surge tank 22 is arranged at the suction path 14.

An airflow meter, a throttle valve 17 and a throttle position sensor are installed in the suction path 14. The airflow meter and the throttle position sensor respectively detect a volume of the suction air passing through the suction path 14 and an opening degree of the throttle valve 17 to transmit the detection results to the engine ECU 10. The engine ECU 10 recognizes the volume of the suction air introduced to the suction port 13 and the combustion chamber 11 on the basis of the transmitted detection results, and adjusts the opening degree of the throttle valve 17 to adjust the volume of the suction air.

A turbocharger 19 is arranged at the exhaust path 16. The turbocharger 19 uses the kinetic energy of the exhaust gas passing through the exhaust path 16, thereby allowing a turbine to rotate. Therefore, the suction air that has passed through an air cleaner is compressed to flow into an intercooler. After the compressed suction air is cooled in the intercooler to be temporarily retained in the surge tank 22, it is introduced into the suction path 14. In this case, the engine 1000 is not limited to a supercharged engine provided with the turbocharger 19, and may be a normally aspirated (Natural Aspiration) engine.

The piston 12 is provided with a cavity at the top surface thereof. As for the cavity, the wall surface is formed by a curved surface which is gently continued from a direction of the fuel injection valve 30 to a direction of the spark plug 18, and the fuel injected from the fuel injection valve 30 is introduced to the vicinity of the spark plug 18 along the shape of the wall surface. In this case, the cavity of the piston 12 can be formed in an arbitrary shape at an arbitrary position in response to the specification of the engine 1000. For example, a re-entrant type combustion chamber may be provided in such a manner that a circular cavity is formed at the central portion of the top surface of the piston 12.

The fuel injection valve 30 is mounted in the combustion chamber 11 under the suction port 13. On the basis of an instruction from the ECU 10, the fuel injection valve 30 directly injects the high-pressured fuel supplied from a fuel pump via a fuel path into the combustion chamber 11 through a nozzle hole 32 provided at a front edge portion of a nozzle body 31. The injected fuel is atomized and mixed with the suction air in the combustion chamber 11 to be introduced to the vicinity of the spark plug 18 along the shape of the cavity. The leak fuel of the fuel injection valve 30 is returned from a relief valve to a fuel tank through a relief pipe.

The fuel injection valve 30 is not limited to the arrangement under the suction port 13. The fuel injection valve 30 may be arranged at an arbitrary position in the combustion chamber 11. For example, the fuel injection valve 30 may be arranged such that the fuel is injected from a top center part of the combustion chamber 11.

Here, the engine 1000 may be any one of a gasoline engine using gasoline as the fuel, a diesel engine using a diesel oil as the fuel, and a flexible fuel engine using a fuel containing the gasoline and the diesel oil at an arbitrary ratio. In addition to this, the engine 1000 may be an engine using any fuel which can be injected by the fuel injection valve. The engine system 1 may be a hybrid system which combines the engine 1000 and plural electric motors.

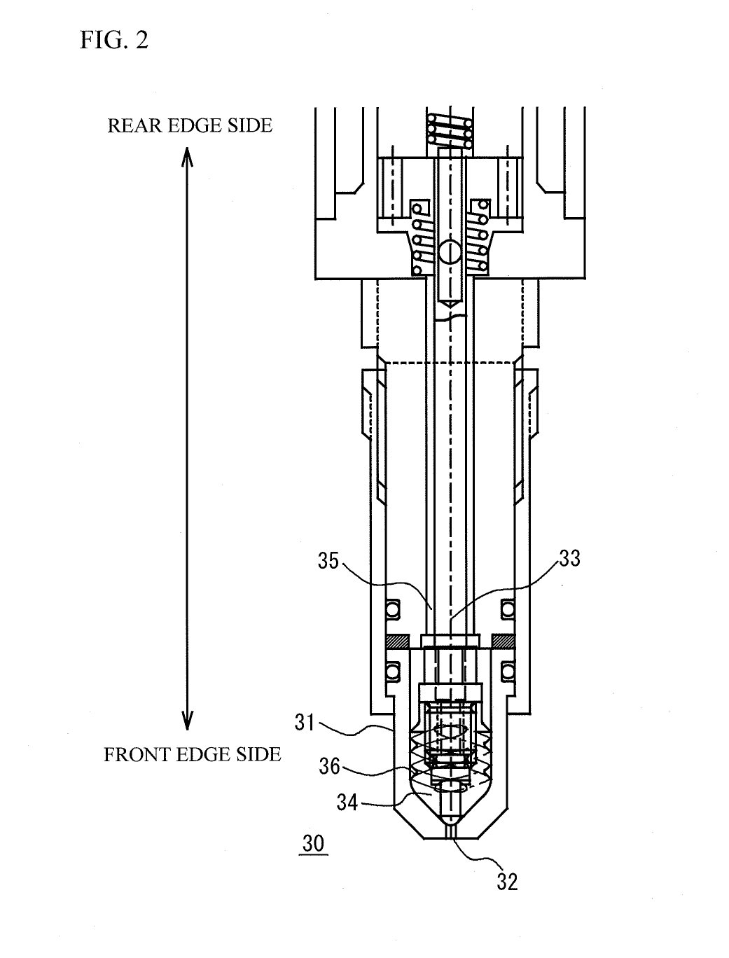

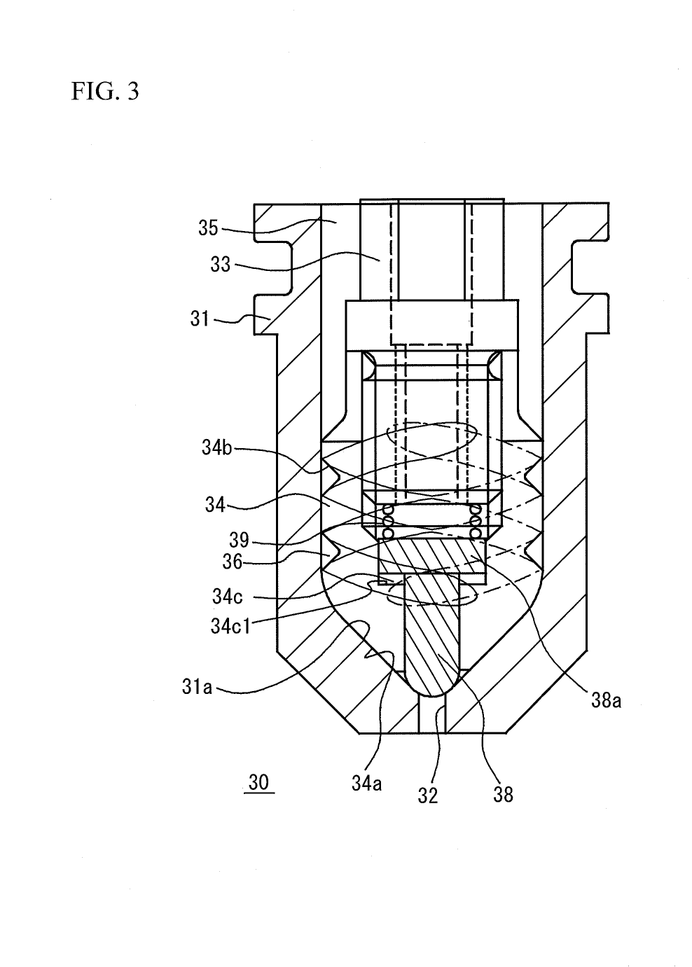

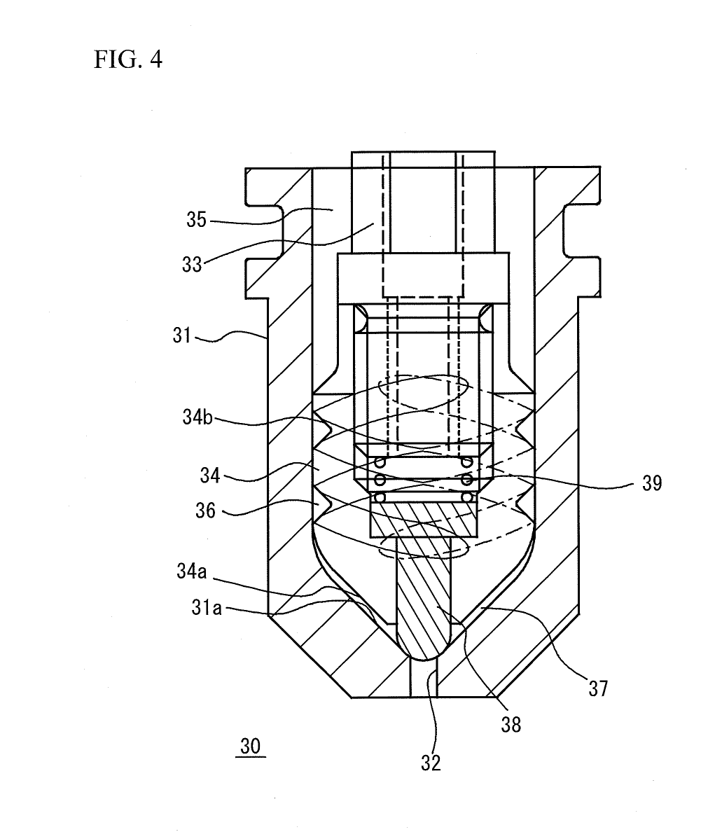

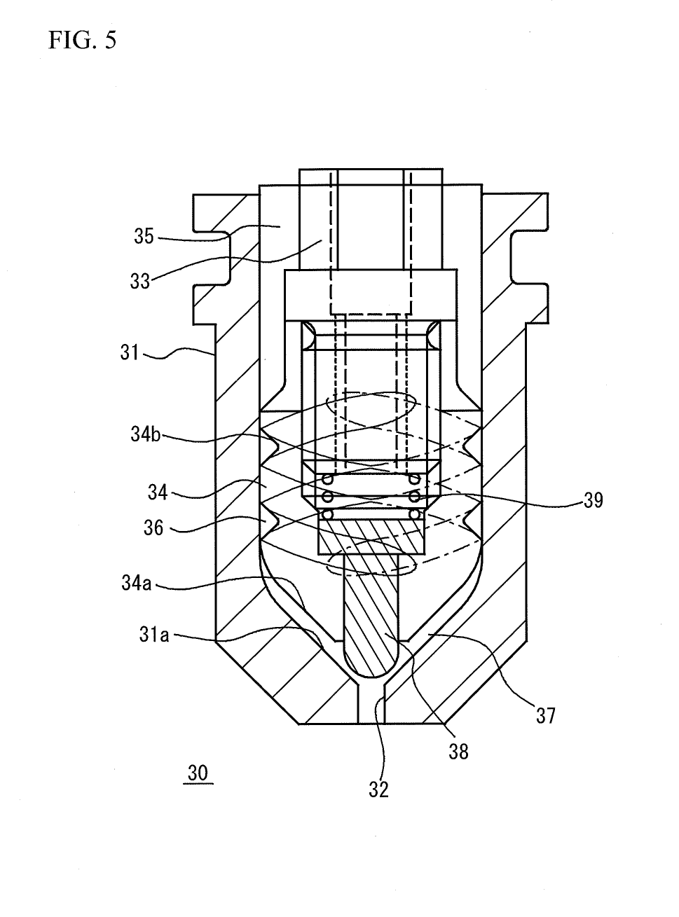

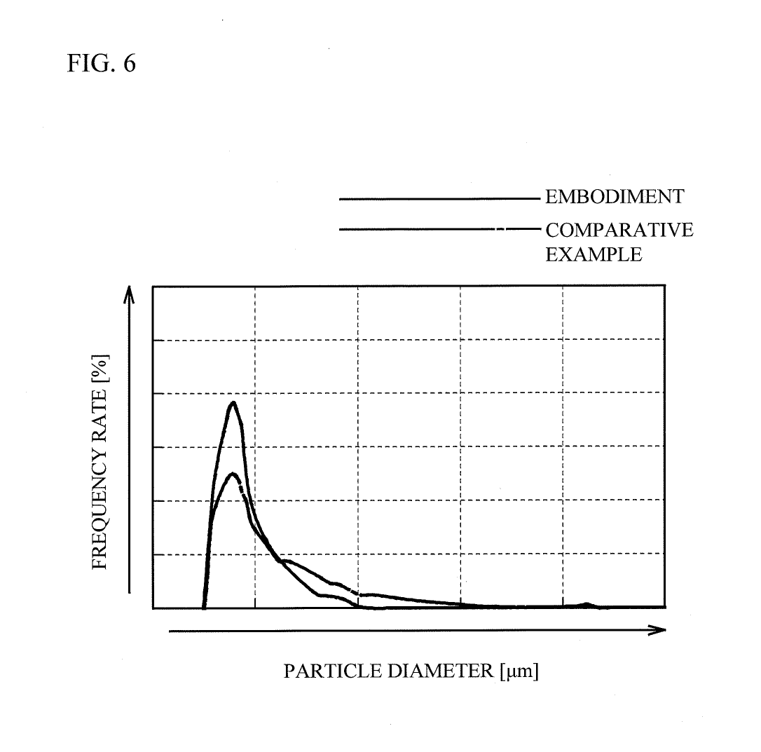

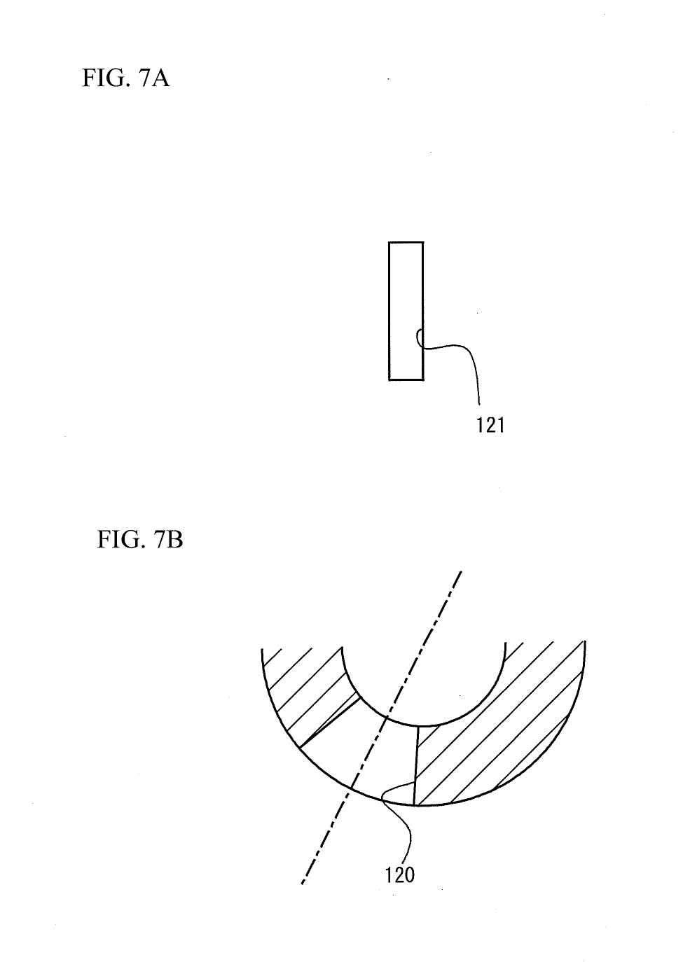

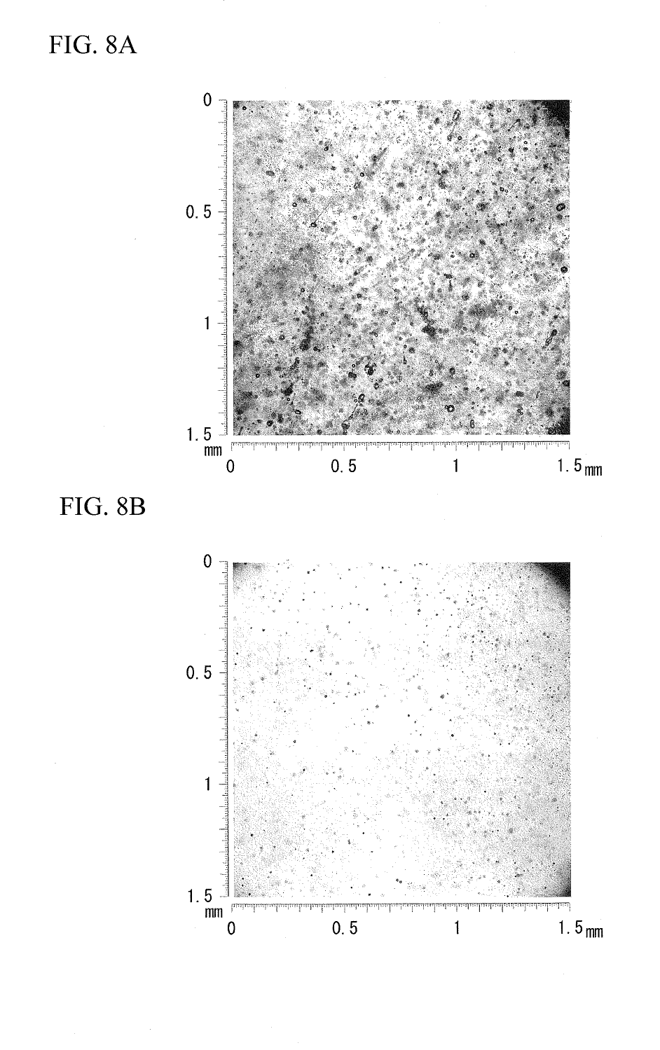

Next, a description will be given of internal structure of the fuel injection valve 30 which is an embodiment of the present invention in detail. FIG. 2 is an explanatory diagram illustrating the schematic structure of the fuel injection valve 30 according to a first embodiment. FIG. 3 is an enlarged explanatory diagram of a front edge portion of the fuel injection valve 30 in a valve closed state according to the first embodiment. FIG. 4 is an enlarged explanatory diagram of the front edge portion of the fuel injection valve 30 according to the first embodiment in which a needle member 33 rises and a first gap (i.e., a suction chamber) 37 is formed while a valve closed state of the nozzle hole 32 is maintaining. FIG. 5 is an enlarged explanatory diagram of the front edge portion of the fuel injection valve 30 in a valve opened state according to the first embodiment. FIG. 6 is a graph illustrating a distribution rate of the particle diameter of the fuel injection valve 30 according to the first embodiment by comparing the fuel injection valve 30 according to the first embodiment with a fuel injection valve 120 of a comparative example. FIG. 7A is an explanatory diagram illustrating a shape of a nozzle hole 121 of the fuel injection valve 120 of the comparative example, as viewed from a lower surface side of the nozzle hole. FIG. 7B is an explanatory diagram illustrating a shape of the nozzle hole 121 of the fuel injection valve 120 of the comparative example, as viewed from the side of the nozzle hole. FIG. 8A is a photograph in which the state of fine bubbles in the fuel injected by the fuel injection valve 120 of the comparison example is captured. FIG. 8B is a photograph in which the state of fine bubbles in the fuel injected by the fuel injection valve 30 of the first embodiment is captured.

The fuel injection valve 30 of the first embodiment includes a nozzle body 31. A taper-shaped seat surface 31a and a nozzle hole 32 are provided on a front edge portion of the nozzle body 31. In the front edge portion of the nozzle body 31, the nozzle hole 32 is a single nozzle hole formed in a direction along an axis of the nozzle body 31. Inside the nozzle body 31, the needle member 33 is slidably arranged in an axial direction. Inside the nozzle body 31, a fuel introduction path 35 is formed between an inner circumferential wall of the nozzle body 31 and the needle member 33. The slide operation of the needle member 33 is controlled by a driving mechanism. The driving mechanism is conventionally known, and is equipped with parts suitable for the operation of the needle member 33, such as an actuator using a piezoelectric element and an electromagnet, and an elastic component which gives a suitable pressure to the needle member 33. It should be noted that, the present specification, a rear edge side and a front edge side of the fuel injection valve 30 are set as illustrated in FIG. 2.

A guide unit 34 whose diameter is expanded and which slidably contacts an inner circumferential surface of the nozzle body 31 is provided in the front edge portion of the needle member 33. The front edge portion of the guide unit 34 includes a taper-shaped seat portion 34a corresponding to the taper shape of the seat surface 31a. A spiral groove 34b is provided on an outer circumferential surface of the guide unit 34. The spiral groove 34b forms a spiral flow path 36 along with the inner circumferential surface of the nozzle body 31. The spiral flow path 36 can give swirling component to the fuel which flows through the nozzle body 31 toward the nozzle hole 32, i.e., the fuel which flows toward the nozzle hole 32 from the fuel introduction path 35. As long as the spiral flow path 36 can give the swirling component to the fuel which flows toward the nozzle hole 32 from the fuel introduction path 35, the spiral flow path 36 may has another configuration. For example, the spiral flow path can be provided inside the wall of the nozzle body 31 by drilling.

The front edge portion of the guide unit 34 can form a first gap 37 between the front edge portion thereof and the inner circumferential surface of the nozzle body 31. The first gap 37 is formed between the guide unit 34 and the inner circumferential surface of the nozzle body 31. At the time of the fuel injection, the guide unit 34 rises toward the rear edge side of the nozzle body 31, and hence the first gap 37 is expanded. That is, the needle member 33 rises toward the rear edge side to expand the first gap 37. The first gap 37 corresponds to a suction chamber.

The fuel injection valve 30 includes a valve member 38 that begins movement to the rear edge side of the nozzle body 31 after the beginning of the rise of the needle member 33 to open the nozzle hole 32. The valve member 38 is mounted on the needle member 33, in particular, a mounting recess 34c provided at the front edge portion of the guide unit 34. The mounting recess 34c includes a hook step 34c1. The valve member 38 includes a hook flange 38a. The hook flange 38a can hook with the hook step 34c1. An elastic member 39 which biases the valve member 38 toward the nozzle hole 32 is attached in the mounting recess 34c.

The fuel injection valve 30 includes a pre-injection swirl flow generating means for causing the fuel to flow through the spiral flow path 36 before the nozzle hole 32 is opened by the valve member 38. Various configuration of the pre-injection swirl flow generating means can be considered. The pre-injection swirl flow generating means is provided at a downstream side of a spiral flow path 35, and can include a fuel suction means that sucks the fuel in the spiral flow path 35 to a downstream side of the spiral flow path 36 before the nozzle hole 32 is opened. The pre-injection swirl flow generating means in the fuel injection valve 30 includes the needle member 33 which expands the first gap 37 corresponding to the suction chamber, and the valve member 38.

When the needle member 33 rises while maintaining the closed state of the nozzle hole 32 as illustrated in FIG. 4 from the closed state of the nozzle hole 32 illustrated in FIG. 3, the seat portion 34a of the guide unit 34 separates from the seat surface 31a, and the first gap 37 (i.e., the suction chamber) is expanded. Then, the first gap 37 begins to be expanded and a negative pressure is generated. Thereby, the fuel in the spiral flow path 36 is sucked to the downstream side of the spiral flow path 36. Since the sucked fuel flows through the spiral flow path 36, the spiral component is given to the sucked fuel. At this time, the valve member 38 is biased by the elastic member 39, and opens the nozzle hole 32. Then, when the hook flange 38a hooks with the hook step 34c1, the valve member 38 begins to move to the rear end side of the nozzle body 31 as illustrated in FIG. 5, and the nozzle hole 32 becomes the opened state. When the nozzle hole 32 is opened, the fuel is injected from the nozzle hole 32. At this time, the flow of the injected fuel has the swirling component, and is easy to generate an air column. Therefore, the fine bubbles can be immediately generated in a boundary between the fuel and the air column. The generated fine bubbles are injected and then crushed to be fine fuel particles.

FIG. 6 is a graph illustrating a distribution rate of the particle diameter of the fuel injected by the fuel injection valve 30 according to the first embodiment by comparing the fuel injection valve according to the first embodiment with a fuel injection valve 120 of a comparative example. In FIG. 6, a solid line indicates the fuel injection valve 30 of the first embodiment, a dashed line indicates the fuel injection valve 120 of the comparative example. As illustrated in FIGS. 7A and 7B, the fuel injection valve 120 of the comparative example is provided with a slit-shape nozzle hole 121 which spreads like a fan toward the front edge portion, as viewed from the side. The fluctuation of the particle diameter of the fuel injected by the fuel injection valve 120 of the comparative example is large. That is, the particle diameter of the fuel is distributed from a large size to a small size. In contrast, the particle diameter of the fuel injected by the fuel injection valve 30 of the first embodiment is intensively distributed in a range of small diameter, and is within a substantially constant range.

Further, by comparing the states of fine bubbles by both photos, a difference thereof is clear. That is, the particle diameter of the fuel injected by the fuel injection valve 120 of the comparative example is coarse and uneven, as illustrated in FIG. 8A. On the contrary, the particle diameter of the fuel injected by the fuel injection valve 30 of the first embodiment is fine and is distributed evenly, as illustrated in FIG. 8B.

It is considered that this is because the fuel injection valve 30 of the first embodiment can inject the fuel containing the fine bubbles immediately after the injection.

In the valve closing time of the fuel injection valve 30, the taper-shaped seat portion 34a sits on the taper-shaped seat surface 31a. Then, the needle member 33 rises while the nozzle hole is being closed by the valve member 38. Thereby, the first gap 37 is expanded and the negative pressure is generated. Then, the swirling component is given to the fuel flowing from the spiral flow path 36 to the first gap 37. When the nozzle hole 32 becomes the opened state, the fuel to which the swirling component is given is injected immediately after the nozzle hole 32 is opened. If a fuel pool is formed at the downstream side of the spiral flow path 36, it is difficult to give the swirling component to the fuel stored in the fuel pool in the valve closed state. On the contrary, in the valve closing time, the taper-shaped seat portion 34a is in close contact with the taper-shaped seat surface 31a, and the volume of the first gap 37 is made closer to zero. Thereby, the fuel to which the swirling component is given can be injected immediately after the beginning of the injection. That is, the fuel sucked from the spiral flow path 36 is run and swirled by the negative pressure generated in the first gap 37, and is injected from the nozzle hole 32.

Moreover, since the fuel is sucked by the negative pressure generated in the first gap 37, the pressure loss by the spiral flow path 36 can be reduced as a merit of the fuel injection valve 30 of the first embodiment. As a result, it is possible to reduce the fuel pressure, and achieve cost reduction and reduction of driving loss of a fuel pump.

Since the nozzle body 31 is provided with the taper-shaped seat surface 31a at its front edge portion, the flow velocity of the fuel that has flowed through the spiral flow path 36 can be increased. That is, a radius of gyration of the swirling flow is narrowed gradually by the taper shape. The swirling flow flows in a narrow region which is reduced in diameter, so that a swirling velocity increases. The swirling flow in which the swirling velocity has increased causes the negative pressure in the center thereof, and forms the air column in the nozzle hole 32. When the air column is generated, the fine bubbles are easily generated in the boundary between the fuel and the air column, and the fuel can be atomized effectively. Thus, the spray of the fuel injected by the fuel injection valve 30 is atomized, so that prompt flame propagation in the combustion chamber 11 is realized and stable combustion is performed. The spray of the fuel is atomized, so that the vaporization of the fuel is promoted. Thereby, it is possible to reduce PM (Particulate Matter), and HC (hydrocarbons). In addition, the thermal efficiency is also improved. Furthermore, since the bubbles are injected from the fuel injection valve 30 and then are destroyed, it is possible to suppress the EGR erosion of the fuel injection valve 30.

The taper shapes of the seat surface 31a and the seat portion 34a are also advantageous to reduce a flow resistance when the fuel flows through the seat portion 34a and the seat surface 31a. Moreover, the taper-shaped seat surface 31a is in close contact with the taper-shaped seat portion 34a, so that a pressure difference in the valve member 38 is reduced. As a result, the oil tightness can be also improved. In addition, the elastic member 39 functions as a buffer material of the valve closing time, and can suppress the seat bounce. Therefore, the oil tightness can be improved, and dribbling of the spray can be suppressed.

Thus, according to the fuel injection valve 30 of the first embodiment, it is possible to inject the fuel containing the fine bubbles from the initial stage of fuel injection from the nozzle hole 32, and atomize the fuel by collapsing the bubble after the injection.

### Second Embodiment

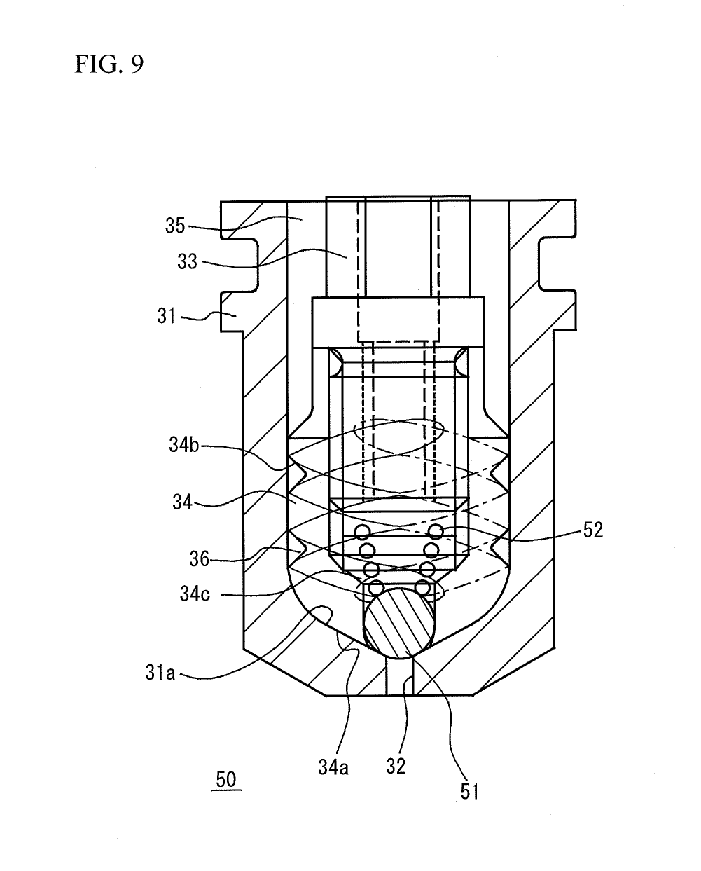

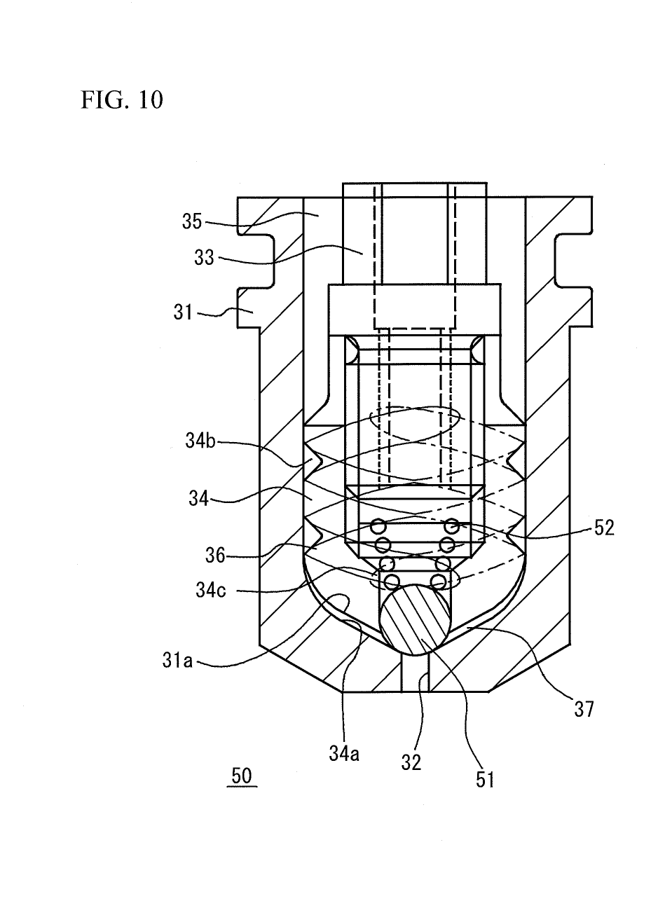

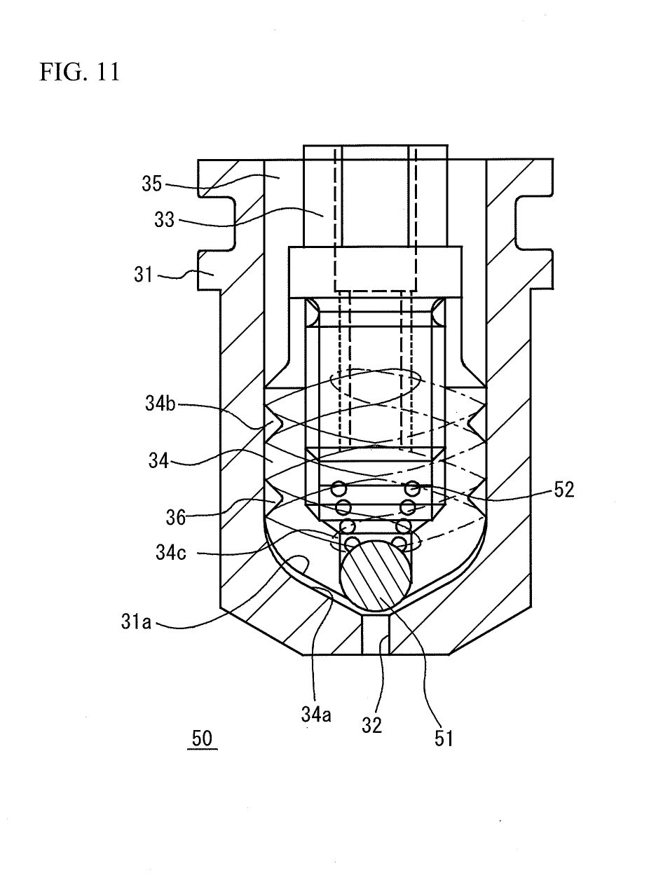

Next, a description will be given of a second embodiment with reference to FIGS. 9 to 11. FIG. 9 is an enlarged explanatory diagram of the front edge portion of a fuel injection valve 50 in the valve closed state according to a second embodiment. FIG. 10 is an enlarged explanatory diagram of the front edge portion of the fuel injection valve 50 according to the second embodiment in which the needle member 33 rises and the first gap 37 is expanded while the valve closed state of the nozzle hole 32 is maintaining. FIG. 11 is an enlarged explanatory diagram of the front edge portion of the fuel injection valve 50 in the valve opened state according to the second embodiment.

The fuel injection valve 50 of the second embodiment differs from the fuel injection valve 30 of the first embodiment in the following points. That is, the fuel injection valve 50 of the second embodiment includes a valve member 51 instead of the valve member 38 included in the fuel injection valve 30. Further, the fuel injection valve 50 includes an elastic member 52 instead of the elastic member 39. Since other components are the same as those in the first embodiment, the components are designated by identical reference numerals in the drawings, and detailed description of the components is omitted. However, each component may involve some shape changes.

The valve member 51 is sphere. The elastic member 52 is a helical spring member having a shape corresponding to the shape of the valve member 51. In the state illustrated in FIGS. 9 and 10, the valve member 51 closes the nozzle hole 32. Since alignment of the spherical valve member 51 is easy, sealing performance of the fuel is high and a defect of the oil tight can be suppressed. Even when the fuel injection valve 50 becomes the valve opened state once, and then becomes the valve closed state again, as illustrated in FIG. 11, the alignment of the valve member is automatically performed, and the oil tight is maintained. By maintaining the oil tight, fuel dripping is suppressed.

Generally, a movable member that extends in the axial direction in the fuel injection valve suppresses the inclination of the movable member by extending a sliding surface in the axial direction. For example, when the valve member for closing the nozzle hole is also elongated in the axial direction, a certain degree of length is ensured in the axial direction in order to suppress the inclination of the valve member and ensure the sealing performance. Therefore, the size of the fuel injection valve tends to become large. On the contrary, by employing the spherical valve member 51, the size of the fuel injection valve 50 can be suppressed small.

According to the fuel injection valve of the second embodiment, it is possible to inject the fuel containing the fine bubbles from the initial stage of fuel injection from the nozzle hole 32, and atomize the fuel by collapsing the bubble after the injection, as is the case with the fuel injection valve 30 of the first embodiment.

### Third Embodiment

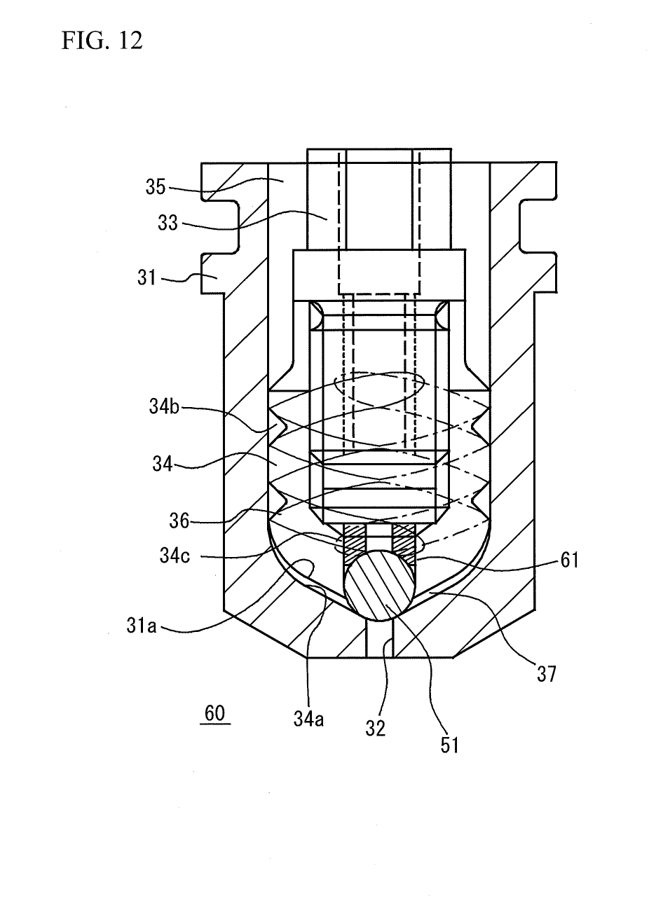

Next, a description will be given of a fuel injection valve 60 of a third embodiment with reference to FIG. 12. FIG. 12 is an enlarged explanatory diagram of the front edge portion of the fuel injection valve according to the third embodiment in which the needle member 33 rises and the first gap (i.e., the suction chamber) 37 is expanded while the valve closed state of the nozzle hole 32 is maintaining.

The fuel injection valve 60 of the third embodiment differs from the fuel injection valve 50 of the second embodiment in the following points. That is, the fuel injection valve 60 includes an elastic member 61 instead of the elastic member 52 included in the fuel injection valve 50. Since other components in the fuel injection valve 60 are the same as those in the fuel injection valve 50, the common components are designated by identical reference numerals in the drawings, and detailed description of the common components is omitted.

The elastic member 52 is the helical spring member, whereas the elastic member 61 is a tubular member. The tubular member is easily fit to the spherical valve member 58. By reducing the diameter of the valve member 58, an area to which a combustion pressure is applied can be reduced. Thereby, a mounting load of the injection valve can be also reduced, and further, for example, injection can be realized with a high response even when an electromagnetic valve-type valve driving mechanism is used. Reducing the area to which the combustion pressure is applied can suppress the invasion of flame into the seat portion and reduce generation and adhesion of deposit.

### Fourth Embodiment

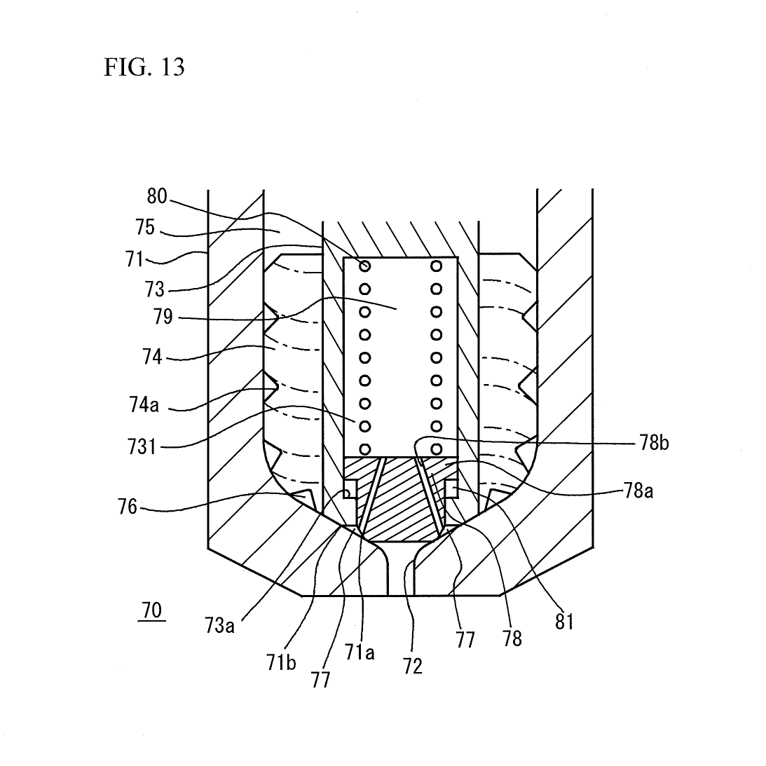

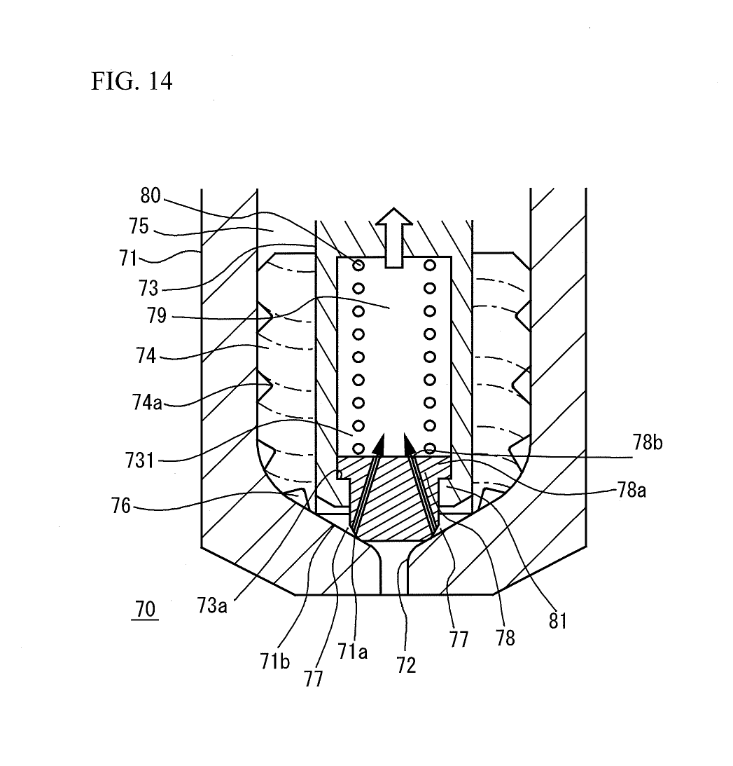

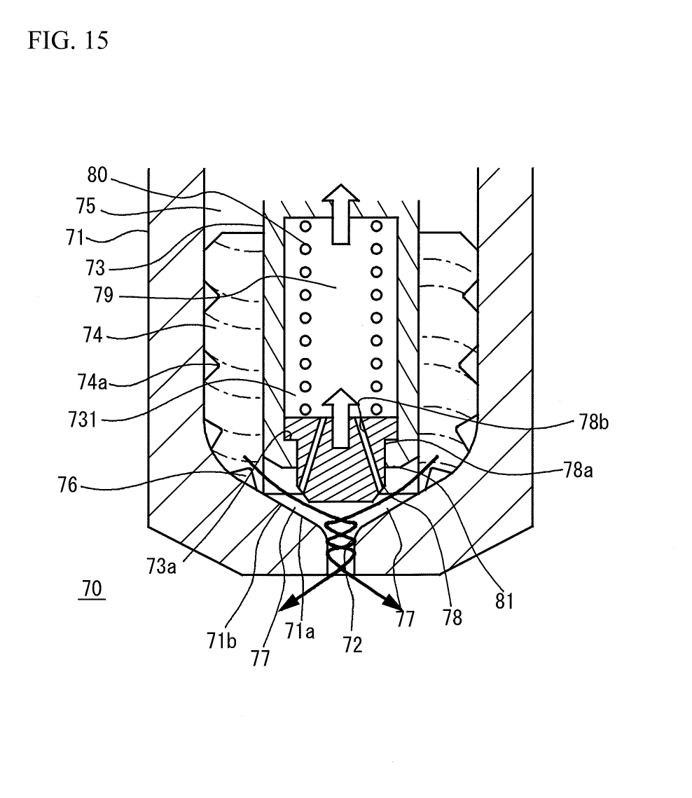

Next, a description will be given of a fuel injection valve 70 according to the fourth embodiment with reference to FIGS. 13 to 15. FIG. 13 is an enlarged explanatory diagram of the front edge portion of the fuel injection valve 70 in the valve closed state according to a fourth embodiment. FIG. 14 is an enlarged explanatory diagram of the front edge portion of the fuel injection valve 70 according to the fourth embodiment in which a needle member 73 rises and the volume of a second gap (i.e., an suction chamber) is expanded while the valve closed state is maintaining. FIG. 15 is an enlarged explanatory diagram of the front edge portion of the fuel injection valve 70 in the valve opened state according to the fourth embodiment.

The fuel injection valve 70 according to the fourth embodiment includes a nozzle body 71. A taper-shaped seat surface 71a and a taper-shaped seat surface 71b are provided in the front edge portion of the nozzle body 71. Moreover, a nozzle hole 72 is provided in the front edge portion of the nozzle body 71. In the front edge portion of the nozzle body 71, the nozzle hole 72 is a single nozzle hole formed in a direction along an axis of the nozzle body 71. Inside the nozzle body 71, the needle member 73 is slidably arranged in an axis direction. The needle member 73 is included in the pre-injection swirl flow generating means. The needle member 73 rises to the rear end side of the nozzle body 71 at the time of fuel injection of the fuel injection valve 70. Inside the nozzle body 71, a fuel introduction path 75 is formed between an inner circumferential wall of the nozzle body 71 and the needle member 73. The slide operation of the needle member 73 is controlled by a driving mechanism. The driving mechanism is conventionally known, and is equipped with parts suitable for the operation of the needle member 73, such as an actuator using a piezoelectric element and an electromagnet, and an elastic component which gives a suitable pressure to the needle member 73. The front edge portion of the needle member 73 sits on the seat surface 71a. Then, a front edge portion of a valve member 78 described later sits on the seat surface 71a, so that a first gap 77 is formed. When the needle member 73 begins to rise, the first gap 77 is communicated with the spiral flow path 76.

The front edge portion of the nozzle body 71 is equipped with a guide member 74 press-fitted in an inner circumference surface thereof. The guide member 74 is a tubular member, and the needle member 73 slides in an axial direction on the inner circumference surface of the guide member 74. The spiral groove 74a is provided on the outer circumference surface of the guide member 74. The spiral groove 74a forms the spiral flow path 76 along with the inner circumferential surface of the nozzle body 71. The fuel is introduced into the spiral flow path 76 from the fuel introduction path 75, and the swirling component is given to the flow of the fuel.

The fuel injection valve 70 includes the valve member 78 attached inside a recess 731 formed in the front edge portion of the needle member 73. The valve member 78 is included in the pre-injection swirl flow generating means. The valve member 78 closes the nozzle hole 73 by sitting on the seat surface 71a. The valve member 78 forms the first gap 77 along with the nozzle body 71 and the needle member 73. The valve member 78 includes a hook flange 78a. The hook flange 78a can hook with the hook step 73a provided in a front edge portion of the recess 731. The hook flange 78a hooks with the hook step 73a, so that the valve member 78 rises to the rear end side. That is, the valve member 78 begins movement to the rear edge side of the nozzle body 71 after the beginning of the rise of the needle member 73 to open the nozzle hole 72. In an upstream side of the hook flange 78a, a second gap 79 is formed between the valve member 73 and the needle member 73. An elastic member 80 which biases the valve member 78 in a direction closing the nozzle hole 72 is equipped in the second gap 79. The elastic member 80 is included in the pre-injection swirl flow generating means. A third gap 81 can be formed between the hook flange 78a of the valve member 78 and the hook step 73a. In the valve closing time illustrated in FIG. 13, the hook flange 78a divides the inside of the recess 731 into the second gap 79 and the third gap 81. The valve member 78 includes first communication holes 78b that communicate the first gap 77 with the second gap 79.

When the needle member 73 begins to rise from the valve closed state of FIG. 13, as illustrated in FIG. 14, the volume of the second gap is expanded. When the volume of the second gap is expanded, the negative pressure is generated in the second gap. When the negative pressure is generated in the second gap 79, the fuel in the spiral flow path 76 is sucked via the second gap 79 and the first communication holes 78b. That is, the second gap 79 functions as a suction chamber.

Since the sucked fuel flows through the spiral flow path 76, the spiral component is given to the sucked fuel. At this time, the valve member 78 is biased by the elastic member 80, and opens the nozzle hole 72. Then, when the hook flange 78a hooks with the hook step 73a, the valve member 78 begins to move to the rear end side of the nozzle body 71 as illustrated in FIG. 15, and the nozzle hole 72 becomes the opened state. When the nozzle hole 72 is opened, the fuel is injected from the nozzle hole 72. At this time, the flow of the injected fuel has the swirling component, and is easy to generate an air column. Therefore, the fine bubbles can be immediately generated in a boundary between the fuel and the air column. The generated fine bubbles are injected and then crushed to be fine fuel particles.

Thus, according to the fuel injection valve 70 of the fourth embodiment, it is possible to inject the fuel containing the fine bubbles from the initial stage of fuel injection from the nozzle hole 72, and atomize the fuel by collapsing the bubble after the injection.

### Fifth Embodiment

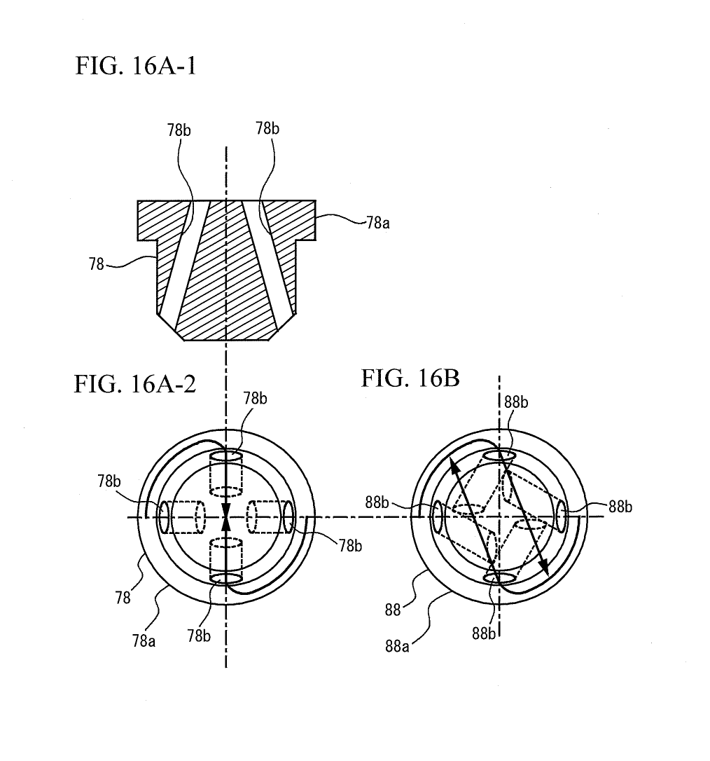

Next, a description will be given of a fifth embodiment with reference to FIGS. 16A-1, 16A-2 and 16B. The fifth embodiment is an example in which the valve member 78 of the fourth embodiment is changed to a valve member 88. FIG. 16A-1 is a cross-section diagram of the valve member 78 according to the fourth embodiment. FIG. 16A-2 is a diagram of the valve member 78 according to the fourth embodiment, as viewed from below. FIG. 16B is a diagram of the valve member according to the fifth embodiment, as viewed from below.

As is clear from FIG. 16A-2, the first communication holes 78b provided in the valve member 78 of the fourth embodiment are extended radially, as viewed from below. On the contrary, first communication holes 88b provided in the valve member 88 extend in directions along a flow direction of the fuel which flows through the spiral flow path 76. As described in the fourth embodiment, when the negative pressure is generated in the second gap 79, the fuel having flowed through the spiral flow path 76 is sucked. The flow of the fuel having flowed through the spiral flow path 76 has the swirling component. The first communication holes 88b are formed so that the swirling component is not interrupted as much as possible.

Thereby, the resistance of the flow path can be reduced, and improvement in the flow velocity of the fuel can also be expected. When the flow velocity of the fuel improves, it becomes easy to generate the air column and advantageous to generation of the fine bubbles. Here, the valve member 88 includes a hook flange 88a, as is the case with the valve member 78.

### Sixth Embodiment

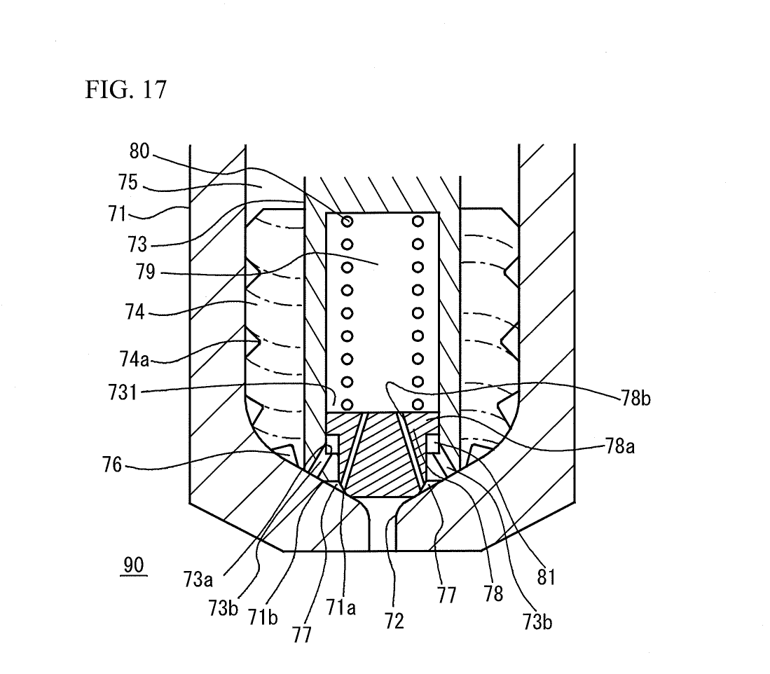

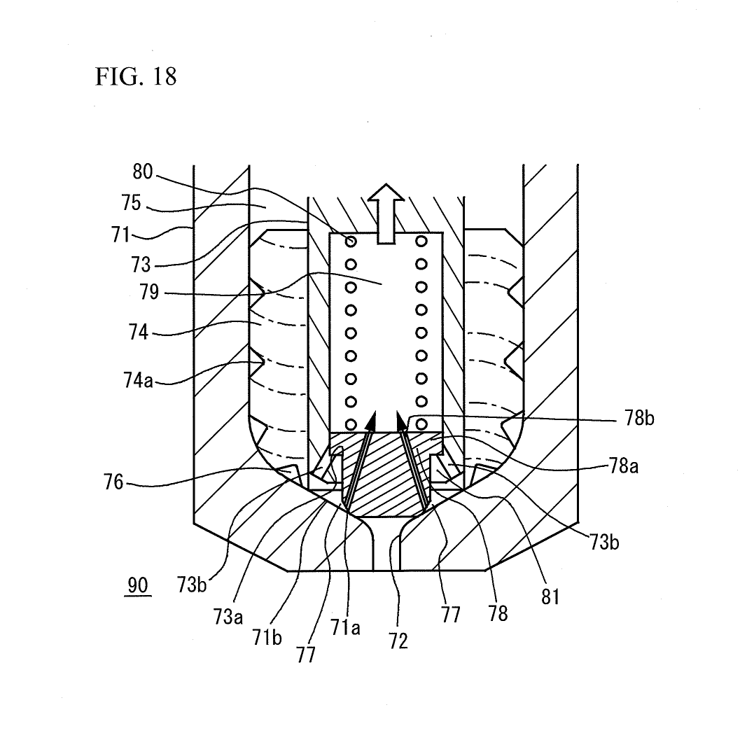

Next, a description will be given of an fuel injection valve 90 according to a sixth embodiment with reference to FIGS. 17 and 18. FIG. 17 is an enlarged explanatory diagram of a front edge portion of the fuel injection valve 90 in the valve closed state according to the sixth embodiment. FIG. 18 is an enlarged explanatory diagram of the front edge portion of the fuel injection valve 90 according to the sixth embodiment in which the needle member 73 rises while the valve closed state is maintaining.

The fuel injection valve 90 of the sixth embodiment differs from the fuel injection valve 70 of the fourth embodiment in the following points. The needle member 73 includes the hook step 73a that hooks with the hook flange 78a included in the valve member in the recess 731 formed in the front edge portion of the needle member 73, and that forms the third gap 81 between the hook flange 78a and the hook step 73a. In addition, the needle member 73 includes second communication holes 73b that communicate the third gap 81 with the outside of the needle member 73.

Since other components are the same as those in the sixth embodiment, the same components are designated by identical reference numerals in the drawings, and detailed description of the same components is omitted.

The valve member 78 begins to rise after timing of beginning of the rise of needle member 73. That is, after the rise of the needle member 73 is begun, the closing of the nozzle hole 72 is continued for a while. In order to create a gap of the timings of the rise of such both members, the valve member 78 can include the hook flange 78a and the needle member can include the hook step. When the hook flange 78a engages with the hook step 73a included in the rising needle member 73, the valve member 78a begins to rise, but for the meantime, the third gap 81 exists between the hook flange 78a and the hook step 73a. When the fuel exists in the third gap 81, it is considered that it becomes difficult that the hook flange 78a approaches the hook step 73a. Therefore, the needle member 73 includes second communication holes 73b that can discharge the fuel in the third gap 81 outside the needle member 73.

It is considered that the fuel which exists in the third gap 81 affects the closing of the nozzle hole 72 by the valve member 78. That is, it is considered that the fuel which exists in the third gap 81 has an action which puts back the valve member 78 to the rear edge side. In order to eliminate such an action, it is desirable to discharge the fuel from the third gap 81. The second communication holes 73b can discharge the fuel from the third gap 81.

### Seventh Embodiment

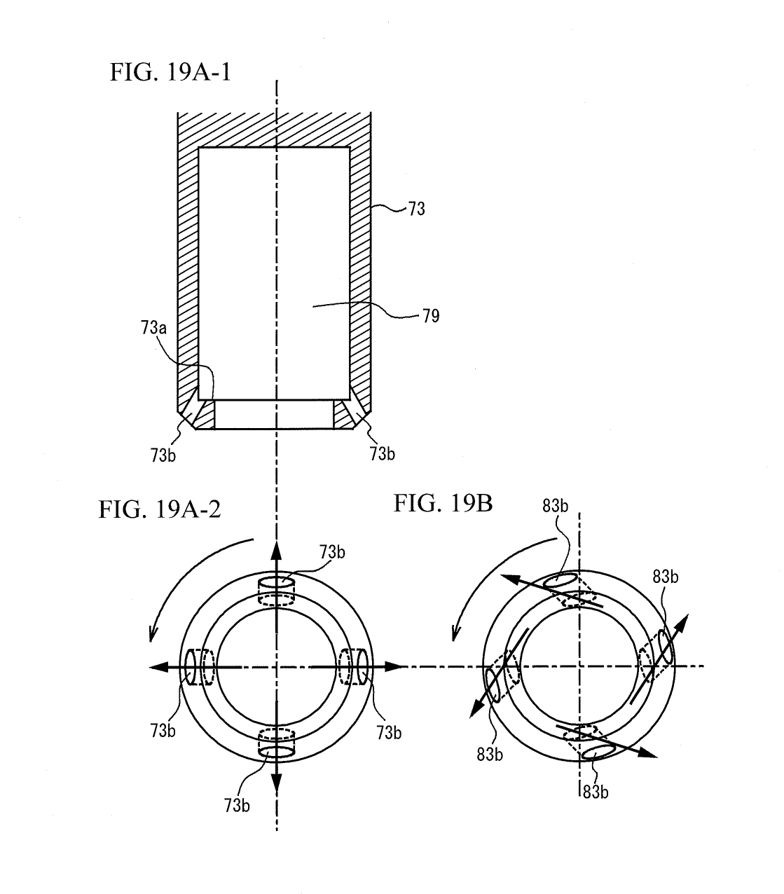

Next, a description will be given of a seventh embodiment with reference to FIGS. 19A-1, 19A-2 and 19B. The seventh embodiment is an example in which the needle member 73 of the sixth embodiment is changed to a needle member 83. FIG. 19A-1 is a cross-section diagram of the needle member 73 according to the sixth embodiment. FIG. 19A-2 is a diagram of the needle member 73 according to the sixth embodiment, as viewed from below. FIG. 19B is a diagram of the needle member 83 according to the seventh embodiment, as viewed from below.

As is clear from FIG. 19A-2, the second communication holes 73b provided in the needle member 73 of the sixth embodiment are extended radially, as viewed from below. On the contrary, second communication holes 83b provided in the needle member 83 extend in directions along a flow direction of the fuel which flows through the spiral flow path 76. The flow of the fuel having flowed through the spiral flow path 76 has the swirling component. The second communication holes 83b are formed so that the swirling component is not interrupted as much as possible.

Thereby, the fuel is easily released from the third gap 81, and holding capability of the closed valve of the nozzle hole 72 by the valve member 78 is improved.

### Eighth Embodiment

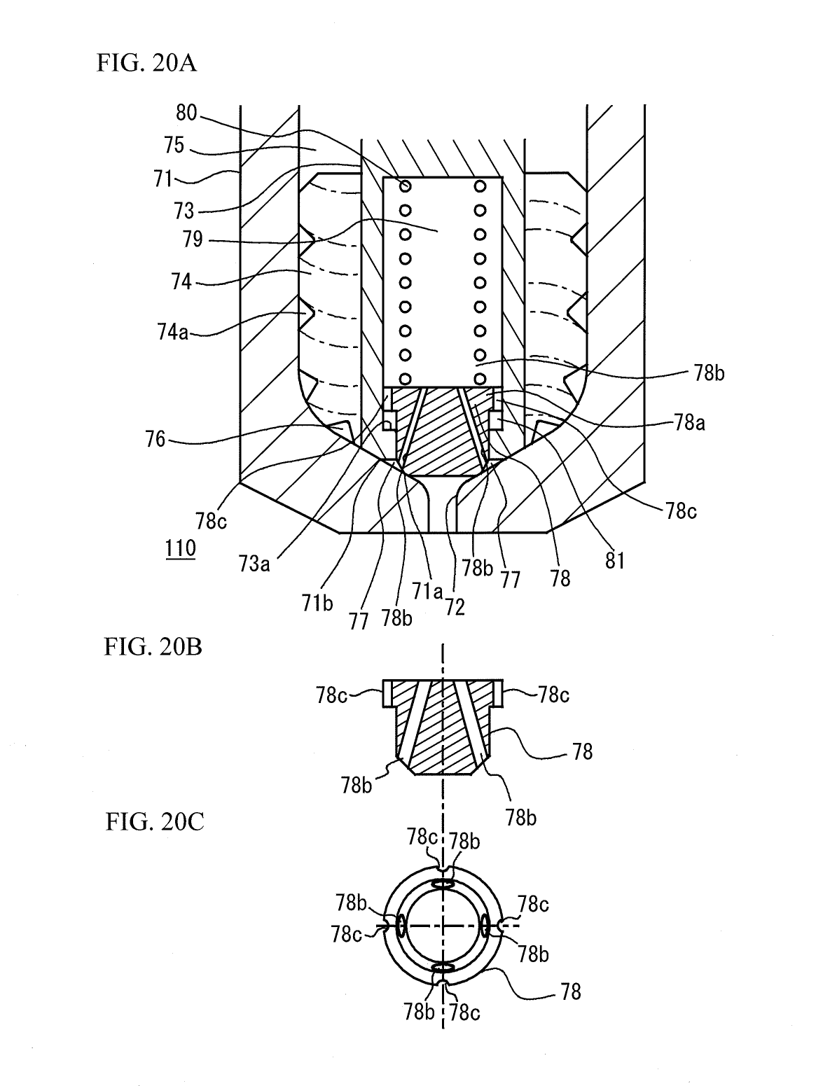

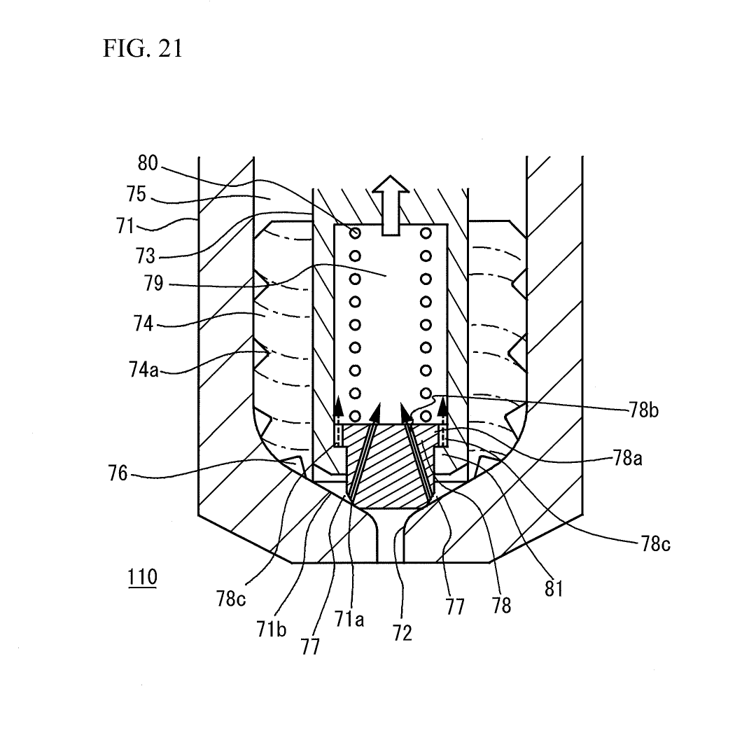

Next, a description will be given of a fuel injection valve 110 according to the eighth embodiment with reference to FIGS. 20A, 20B, 20C and 21. FIG. 20A is an enlarged explanatory diagram of the front edge portion of the fuel injection valve 110 in the valve closed state according to the eighth embodiment. FIG. 20B is a cross-section diagram of the valve member according to the eighth embodiment. FIG. 20C is a diagram of the valve member according to the eighth embodiment, as viewed from below. FIG. 21 is an enlarged explanatory diagram of the front edge portion of the fuel injection valve 110 according to the eighth embodiment in which the needle member 73 rises while the valve closed state is maintaining.

The fuel injection valve 110 of the eighth embodiment differs from the fuel injection valve of the fourth embodiment in the following points. The valve member 78 forms third communication holes 78c that communicate the second gap 79 with the third gap 81. The third communication holes 78c can be equipped along with or instead of the second communication holes 73b of the sixth embodiment and the second communication holes 83b of the seventh embodiment.

The third communication holes 78c can discharge the fuel in the third gap 81 into the second gap 79, as illustrated in FIG. 21. The fuel is discharged from the third gap 81, so that the hook flange 78a easily approaches the hook step 73a and holding capability of the closed valve of the nozzle hole 72 is improved.

### Ninth Embodiment

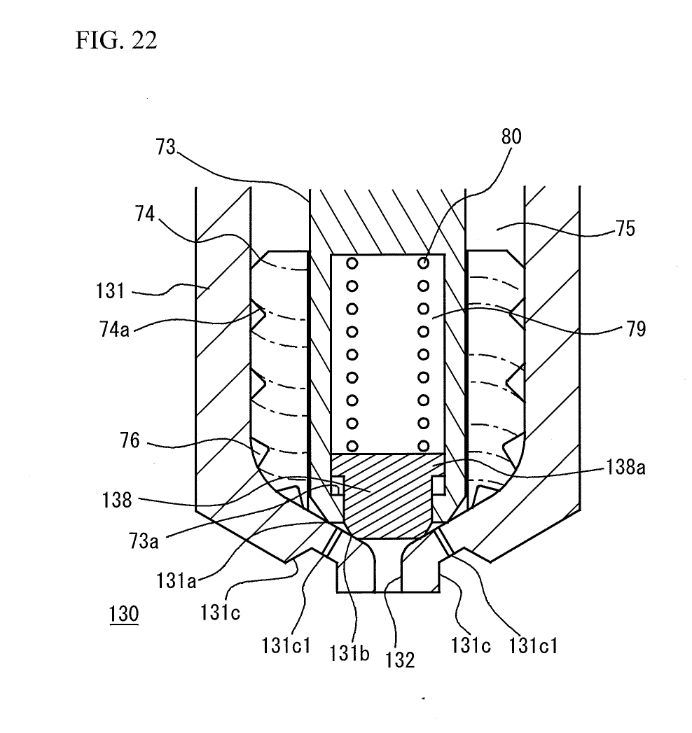

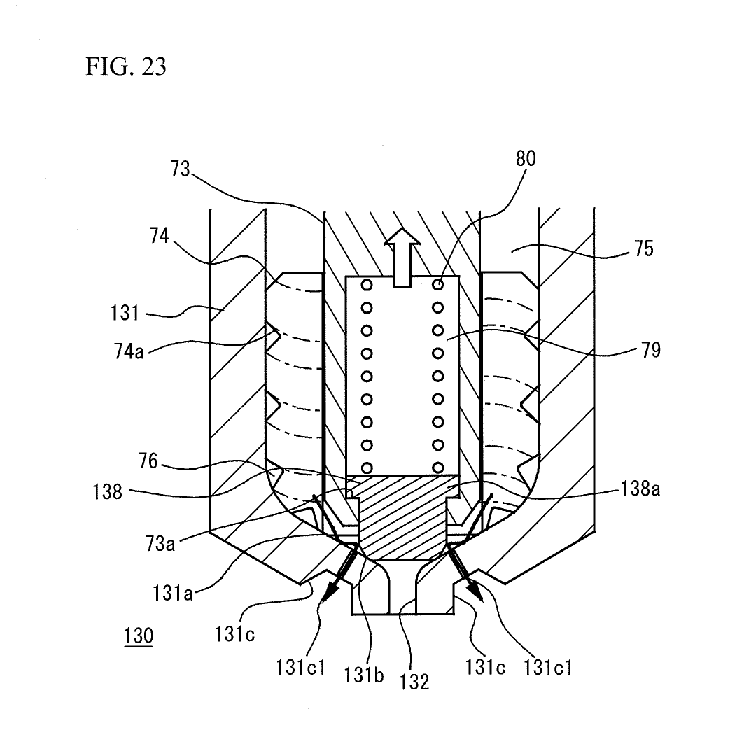

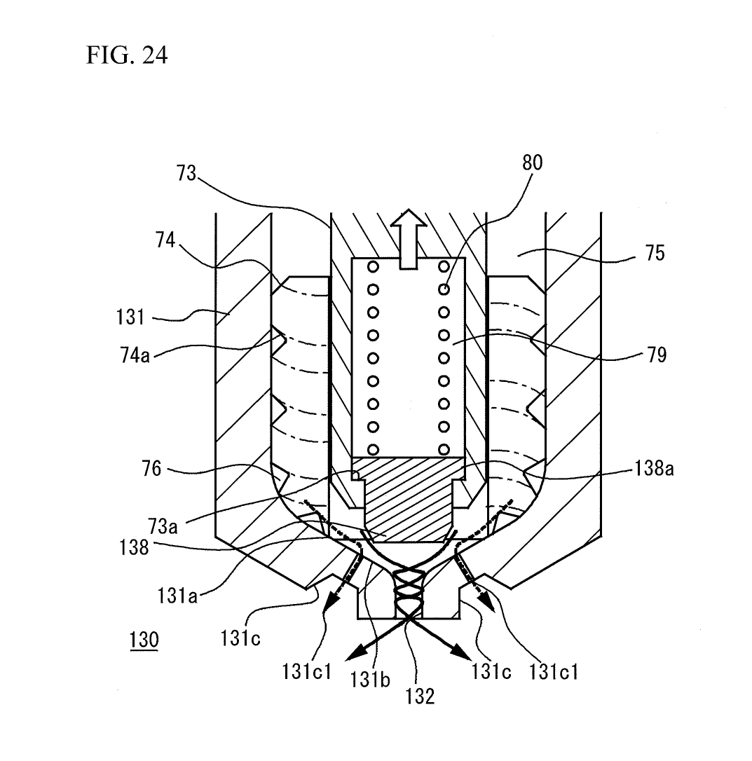

Next, a description will be given of a fuel injection valve 130 according to a ninth embodiment with reference to FIGS. 22, 23 and 24. FIG. 22 is an enlarged explanatory diagram of a front edge portion of a fuel injection valve 130 in the valve closed state according to the ninth embodiment. FIG. 23 is an enlarged explanatory diagram of the front edge portion of the fuel injection valve 130 according to the ninth embodiment in which the needle member 73 rises and the fuel is discharged from a fuel exhaust hole 131c1 while the valve closed state of the nozzle hole 132 is maintaining. FIG. 24 is an enlarged explanatory diagram of the front edge portion of the fuel injection valve 130 in the valve opened state according to the ninth embodiment.

The fuel injection valve 130 of the ninth embodiment differs from the fuel injection valve of the fourth embodiment in the following points. The fuel injection valve 130 of the ninth embodiment includes a nozzle body 131 instead of the nozzle body 71 of fourth embodiment. The fuel injection valve 130 includes a valve member 138 instead of the valve member 78.

The nozzle body 131 includes a seat surface 131a and a seat surface 131b. The front edge portion of the needle member 73 sits on the seat surface 131a. The valve member 138 sits on the seat surface 131b. Counter bores 131c are provided in the front edge portion of the nozzle body 131. The nozzle body 131 includes fuel exhaust holes 131c1 that communicate the counter bores 131c with the inside of the nozzle body 131. The fuel exhaust holes 131c1 are included in the pre-injection swirl flow generating means. The communication between the fuel exhaust holes 131c1 and the spiral flow path 76 is interrupted in a state where the needle member 73 sits on the seat surface 131a as illustrated in FIG. 22. Then, when the needle member 73 begins to rise while the valve member 138 is maintaining the closing of the nozzle hole 132, the spiral flow path 76 communicates with the fuel exhaust holes 131c1. Thereby, the fuel in the spiral flow path 76 begins to flow, and is discharged outside the nozzle body 131. Thereby, the flow of fuel is generated, and further the fuel in the spiral flow path 76 is continuously sucked.

Since the sucked fuel flows through the spiral flow path 76, the spiral component is given to the sucked fuel. At this time, the valve member 78 is biased by the elastic member 80, and closes the nozzle hole 172. Then, when the hook flange 138a engages with the hook step 73a, the valve member 138 begins to move to the rear end side of the nozzle body 71 as illustrated in FIG. 24, and the nozzle hole 132 becomes the opened state. When the nozzle hole 132 is opened, the fuel is injected from the nozzle hole 132. At this time, the flow of the injected fuel has the swirling component, and is easy to generate an air column. Therefore, the fine bubbles can be immediately generated in a boundary between the fuel and the air column. The generated fine bubbles are injected and then crushed to be fine fuel particles.

Since other components are the same as those in the fourth embodiment, the same components are designated by identical reference numerals in the drawings, and detailed description of the same components is omitted.

Here, the valve member 138 can include the first communication holes, as is the case with the valve member 78. However, the valve member 138 according to the ninth embodiment does not include the first communication holes.

### Tenth Embodiment

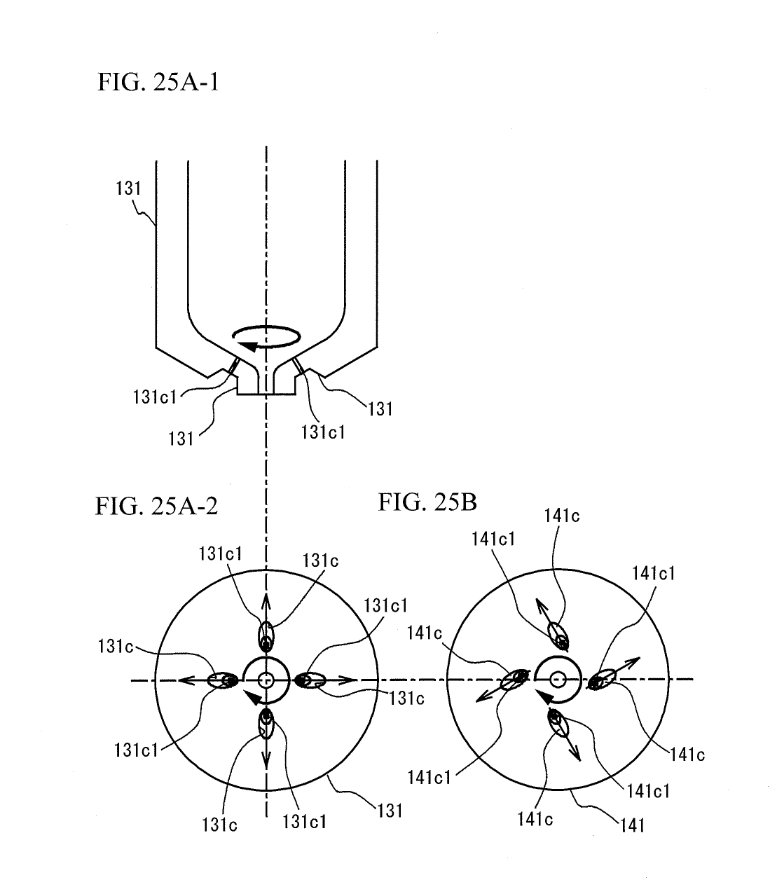

Next, a description will be given of a tenth embodiment with reference to FIGS. 25A-1, 25A-2 and 25B. FIG. 25A-1 is a cross-section diagram of the nozzle body 131 according to the ninth embodiment. FIG. 25A-2 is a diagram of the nozzle body 131 according to the ninth embodiment, as viewed from below. FIG. 25B is a diagram of a nozzle body 141 according to the tenth embodiment, as viewed from below.

As is clear from FIG. 25A-2, the fuel exhaust holes 131c1 and the counter bores 131c provided in the nozzle body 131 of the ninth embodiment are extended radially, as viewed from below. On the contrary, fuel exhaust holes 141c1 and counter bores 141c provided in a nozzle body 141 extend in directions along a flow direction of the fuel which flows through the spiral flow path 76. The flow of the fuel having flowed through the spiral flow path 76 has the swirling component. The fuel exhaust holes 141c1 are formed so that the swirling component is not interrupted as much as possible.

Thereby, the resistance of the flow path can be reduced. By the reduction of the resistance of the flow path, the flow velocity of the fuel can also be improved. When the flow velocity of the fuel increases, it becomes easy to generate the air column and the atomization of the fuel is promoted.

The above-mentioned embodiments are merely examples carrying out the present invention. Therefore, the present invention is not limited to those, and various modification and change could be made hereto without departing from the spirit and scope of the claimed present invention.

### DESCRIPTION OF LETTERS OR NUMERALS

30, 50, 60, 70, 90, 110, 130 . . . fuel injection valve
31, 71, 131 . . . nozzle body
31a, 71a, 71b, 131a, 131b . . . seat surface
32, 72, 132 . . . nozzle hole
33, 73 . . . needle member
34 . . . guide unit
34b . . . spiral groove
731 . . . recess
73a . . . hook step
73b, 83b . . . second communication hole
73c . . . third communication hole
34c1 . . . hook step
35, 75 . . . fuel introduction path
36, 76 . . . spiral flow path
37 . . . first gap (suction chamber)
77 . . . first gap
38, 51, 78, 88, 138 . . . valve member
38a, 78a, 138a . . . hook flange
78b, 88b . . . first communication hole
79 . . . second gap
39, 52, 61, 80 . . . elastic member
81 . . . third gap
74 . . . guide member
74a . . . spiral groove
131c . . . counter bore
131c1 . . . fuel exhaust hole

1-12. (canceled)

13. A fuel injection valve comprising:
a nozzle body having a nozzle hole formed in a front edge portion thereof;
a spiral flow path that gives a swirling component to a fuel which passes through the nozzle body toward the nozzle hole; and
a pre-injection swirl flow generating unit that causes the fuel to flow through the spiral flow path before the nozzle hole is opened,
wherein the pre-injection swirl flow generating unit is communicated with the spiral flow path at a downstream side of the spiral flow path, and includes a suction chamber whose volume is expanded before the nozzle hole is opened.

14. The fuel injection valve according to claim 13, wherein the pre-injection swirl flow generating unit includes:
a needle member that is slidably arranged in the nozzle body, and rises toward a rear edge side of the nozzle body at the time of fuel injection to expand a first gap that forms the suction chamber between an inner circumferential surface of the nozzle body and the needle member; and
a valve member that begins movement to the rear edge side of the nozzle body after the beginning of the rise of the needle member to open the nozzle hole.

15. The fuel injection valve according to claim 14, wherein in valve closing time, a seat portion included in the needle member sits on a seat surface included in the nozzle body to make the volume of the first gap close to zero.

16. The fuel injection valve according to claim 14, wherein the valve member is sphere.

17. The fuel injection valve according to claim 13, wherein the pre-injection swirl flow generating unit includes:
a needle member that is slidably arranged in the nozzle body, forms a first gap between an inner circumferential wall of the nozzle body and the needle member before fuel injection, and rises to a rear edge side of the nozzle body at the time of the fuel injection;
a valve member that is mounted inside a recess formed in a front edge portion of the needle member, forms a second gap that forms the suction chamber between the needle member and the valve member, begins movement to the rear edge side of the nozzle body after the beginning of the rise of the needle member to open the nozzle hole, and includes a first communication hole which communicates the first gap with the second gap; and
an elastic member that is arranged in the second gap, and biases the valve member in a direction closing the nozzle hole.

18. The fuel injection valve according to claim 17, wherein the first communication hole extends in a directions along a flow direction of the fuel which passes through the spiral flow path.

19. The fuel injection valve according to claim 17, wherein the needle member includes: a hook step that hooks with a hook flange included in the valve member in the recess formed in the front edge portion of the needle member, and forms a third gap between the hook flange and the hook step; and a second communication hole that communicates the third gap with the outside of the needle member.

20. The fuel injection valve according to claim 19, wherein the second communication hole extends in a directions along a flow direction of the fuel which passes through the spiral flow path.

21. The fuel injection valve according to claim 19, wherein the valve member forms a third communication hole that communicates the second gap with the third gap.

22. A fuel injection valve comprising:
a nozzle body having a nozzle hole formed in a front edge portion thereof;
a spiral flow path that gives a swirling component to a fuel which passes through the nozzle body toward the nozzle hole; and
a pre-injection swirl flow generating unit that causes the fuel to flow through the spiral flow path before the nozzle hole is opened,
wherein the pre-injection swirl flow generating unit includes:
a fuel exhaust hole that is provided in the nozzle body, is opened and closed by the needle member, and discharges the fuel outside the nozzle body before the nozzle hole is opened.

23. The fuel injection valve according to claim 22, wherein the fuel exhaust hole extends in a directions along a flow direction of the fuel which passes through the spiral flow path.
